(19) United States
(12) Patent Application Publication
(10) Pub. No.: US 2010/0047494 A1
(43) Pub. Date: Feb. 25, 2010

(54) SILVER/PLASTIC COMBINATION THAT BINDS HAZARDOUS AGENTS AND PROVIDES ANTI-MICROBIAL PROTECTION

(76) Inventor: Roy J. Mankovitz, Montecito, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/609,606

(22) Filed: Oct. 30, 2009

Related U.S. Application Data
(63) Continuation-in-part of application No. 11/796,113, filed on Apr. 25, 2007.
(60) Provisional application No. 60/798,077, filed on May 5, 2006.

(51) Int. Cl. B32B 1/02

(52) U.S. Cl. 428/35.8

(57) ABSTRACT

Containers and container liners are provided according to embodiments of the present invention. In particular embodiments of the present invention, containers and container liners are provided which include micronized silver and a bisphenol A epoxy resin and/or a bisphenol A polycarbonate.

### REFERENCE TO PRIOR APPLICATIONS

This application is a continuation-in-part of U.S. patent application Ser. No. 11/796,113, filed Apr. 25, 2007, which claims priority to U.S. Provisional Patent Application Ser. No. 60/798,077, filed May 5, 2006. The entire content of each application is incorporated herein by reference.

### FIELD OF THE INVENTION

The present invention relates generally to the field of plastic water bottles, and in particular to a plastic water bottle that eliminates hazardous chemical leaching while adding anti-microbial properties.

### BACKGROUND OF THE INVENTION

For centuries, silver has been known to impart anti-microbial properties to persons who consume it in its proper form, i.e., it its colloidal ionic form. Studies on the effectiveness of silver as an antimicrobial have shown that silver in its ionic form, rather than its particulate form, has the ability to inhibit the growth of staph, E. coli. and other bacteria. It has been shown to act as an anti-biotic as well as a tissue regenerator. The use of colloidal ionic silver has demonstrated its analgesic and anti-inflammatory effects as well.

Silver ions made into a hydrosol, i.e., a liquid that contains the positively charged silver cations without the presence of negatively charged anions, has been shown to be as gentle as water on the consumer. Research in this area has shown that this silver ion activity is oligodynamic, i.e., it is active in very small quantities. Because it is effective in small quantities, the possible side effect of argyria wherein a patient develops blue skin after exposure to high quantities of silver, becomes remote to non-existent. Additionally, because it is effective in small quantities, it is relatively inexpensive to administer.

It is noteworthy that colloidal ionic silver offered as a dietary supplement to boost the immune system is typically offered in glass containers. The reason given for this is that the silver tends to leach chemicals from plastics. It is this phenomenon, combined with the anti-microbial properties of colloidal ionic silver the instant invention seeks to exploit.

Plastic water bottles have become de rigeur in contemporary society. For convenience and healthy hydration, it is commonplace for people to use plastic water bottles to carry water with them wherever they are to keep themselves hydrated. Plastic is cheap and lightweight and is generally preferred over glass or stainless steel as a means for transporting small amounts of drinking water.

A particularly popular plastic used for drinking water is polycarbonate, particularly because of its hardiness. There is a major downside to the use of polycarbonate, however. Polycarbonate is made of the bisphenol-A monomer, which is a hazardous chemical that leaches into water stored in a polycarbonate water bottle.

Bisphenol-A can be leached into a water bottle contents through normal wear and tear, exposure to heat and cleaning agents. This includes leaving your plastic water bottle in your car during errands, in your back pack during hikes and running it through your dishwasher and using harsh detergents. Detectable levels of bisphenol-A have been found to have leached into liquids at room temperature. Just having your plastic water bottle sitting on your desk can be potentially harmful.

Bisphenol-A can activate estrogen receptors leading to similar physiological effects as the body's own estrogens. Bisphenol-A can impair the reproductive organs and have adverse effects on tumors, breast tissue development and prostate development by reducing sperm count.

Prior art in the field has sought to protect plastic with silver, particularly as an anti-microbial agent. None, however, have sought to bind up hazardous leaching agents, such as bisphenol-A. Westlake Plastic Technologies (www.wptech.com) has developed a plastic resin that incorporates silver into the plastic to create plastic products at risk of bacteria and other microbial contamination, such as food processing and restaurant equipment, cutting boards, countertops, food packaging, ice machine components and bulk food containers.

A silver zeolite has been developed by AGION® Technologies, Inc. The AGION® compound is a combination of silver and zeolite. The zeolite is utilized as a container for the silver so that it does not combine with other substances. U.S. Publication No. 2005/0058682 to Sharratt describes using the silver zeolite product as a coating for surgical instruments.

It is the intent of the instant invention not that the silver be manufactured to avoid interference with other substances. Rather, it is desired that the silver interact with the bisphenol-A, binding it and removing it as a potential hazard to the person drinking out of the polycarbonate water bottle. Silver ions not consumed through binding with the bisphenol-A would remain in the plastic, adding anti-microbial properties both to the water contained in the bottle as well as the skin of the person holding the bottle.

### SUMMARY OF THE INVENTION

The present invention seeks to remove hazardous leaching chemicals from water bottles made of polycarbonate, in particular, bisphenol-A. This is achieved through the addition of colloidal ionic silver to the plastic at the time it is molded to form a drinking water bottle.

It is the primary object of the invention to prevent the leaching of hazardous chemicals, such as bisphenol-A, into the water contained in water bottles made of polycarbonate through the addition of colloidal ionic silver as a binding agent.

In further embodiments of the present invention, micronized silver is included in containers and/or container liners described herein.

It is yet another object of the invention to provide anti-microbial properties to the water contained in a water bottle made of polycarbonate through the use of colloidal ionic silver added to the polycarbonate plastic during molding.

It is yet another object of the invention to provide anti-microbial protection to the user of the silver ion infused water bottle through the transfer of silver to the skin of the user.

The preferred embodiment of the instant invention provides for a container for liquids comprising an internal chamber for housing the liquids; an external shell defining the shape of the internal chamber wherein the external shell contains a quantity of colloidal silver sufficient to provide anti-bacterial, anti-fungal and anti-microbial properties to the external shell and any matter that comes into contact therewith.

The above embodiment can be further modified by defining that the external shell is made of a moldable synthetic plastic.

The above embodiment can be further modified by defining that the external shell is made of polycarbonate.

The above embodiment can be further modified by defining that a means is provided for adding liquids to the container and removal of the liquids therefrom, such as an opening in the top of the container that is sealable with a cap.

The above embodiment can be further modified by defining that a means is provided for adding liquids to the container and removal of the liquids therefrom, such as a spigot located near the bottom of said container.

An alternative embodiment of the present invention is a method of manufacturing a container for liquids that provides anti-bacterial, anti-fungal and anti-microbial properties comprising molding of an exterior shell with a quantity of colloidal silver sufficient to provide said anti-bacterial, anti-fungal and anti-microbial properties to infuse said shell with said colloidal silver; shaping of the exterior shell into a desired to shape that defines an interior chamber for the housing of liquids; placement of liquids into the interior chamber; sealing the liquids in the interior chamber.

The above embodiment can be further modified by defining that the external shell is made of a moldable synthetic plastic.

The above embodiment can be further modified by defining that the external shell is made of polycarbonate.

The above embodiment can be further modified by defining that a means is provided for adding liquids to the container and removal of the liquids therefrom, such as an opening in the top of the container that is sealable with a cap.

The above embodiment can be further modified by defining that a means is provided for adding liquids to the container and removal of the liquids therefrom, such as a spigot located near the bottom of said container.

### DETAILED DESCRIPTION OF A PREFERRED EMBODIMENT

Containers and container liners are provided according to embodiments of the present invention. In particular embodiments of the present invention, containers and container liners are provided which include micronized silver.

Plastics used to make containers and container liners of the present invention are conventional plastics well-known in the art. In preferred embodiments, a container or container liner of the present invention is composed of at least one plastic containing a reaction product of bisphenol A. Plastics containing a reaction product of bisphenol A illustratively include, but are not limited to, bisphenol A epoxy resins and bisphenol A polycarbonates.

Containers and container liners are formed from curable compositions including one or more types of monomers, oligomers, prepolymers, macromonomers and/or polymers, such as homopolymers, copolymers, terpolymers, or other combinations; and micronized silver. The compositions can be cured to form containers and container liners of the present invention.

The term “micronized silver” refers to silver metal powder having an average particle size in the range of 1 nm-10 microns, inclusive.

Micronized silver is included in a plastic and silver composition such that the micronized silver is 0.1-99% by weight of the total weight of the composition. In further embodiments, the micronized silver is 0.2-30% by weight of the total weight of the composition. In further embodiments, the micronized silver is 0.3-10% by weight of the total weight of the composition. In still further embodiments, the micronized silver is 0.5-5% by weight of the total weight of the composition.

In particular embodiments, a container of the present invention includes a wall defining an internal space for housing a desired material. The wall is characterized by an exterior surface, an opposing interior surface adjacent the internal space and a wall thickness extending between the exterior surface and interior surface. As described herein, a container of the present invention is composed of plastic mixed with micronized silver and therefore micronized silver is present in the container wall thickness extending between the exterior surface and interior surface.

In preferred embodiments, the container wall includes a polycarbonate plastic and micronized silver. The polycarbonate plastic is optionally mixed with one or more other types of plastic.

In further embodiments, a container liner is formed using a micronized silver-containing plastic material of the present invention, the container liner including a wall defining an internal space for housing a desired material. The container liner wall is characterized by an exterior surface in contact with a container wall, an opposing interior surface adjacent the internal space and a wall thickness extending between the exterior surface and interior surface. As described herein, a container liner of the present invention is made of plastic mixed with micronized silver and therefore micronized silver is present in the container liner wall thickness extending between the exterior surface and interior surface.

In preferred embodiments, the container liner wall includes an epoxy resin and micronized silver. The epoxy resin is optionally mixed with one or more other types of plastic.

In particular embodiments, a container liner is a can liner.

Container liners are useful in various applications, such as for inhibiting contamination of a contained material, such as metals or container impurities.

Containers and container liners of the present invention can be manufactured using various methods, such as molding, illustratively including, but not limited to, injection molding blow molding, rotational molding, extrusion, and thermoforning.

Container liners can be formed by various methods known in the art illustratively including, but not limited to, spray coating, flow coating, brush coating, roller coating and dip coating.

Bisphenol A polycarbonates, bisphenol A epoxy resins, other plastics, methods of manufacture of these and other plastics are well-known in the art, as exemplified in H. Schnell, Chemistry and Physics of Polycarbonates, Polymer Reviews, vol. 9, Interscience Publishers, New York 1964; Legrand et al., Handbook of Polycarbonate Science and Technology, Marcel Dekker, 2000; and Kirk-Othmer, Encyclopedia of Chemical Technology, 5th Ed., Vol. 10, pp 347-470 and Vol. 19, pp. 797-827, 2007.

Curing modalities for plastic and micronized silver compositions of the present invention are those typically used for conventional curable compositions illustratively including, but not limited to, thermal curing; curing by exposure to actinic radiation, such as ultraviolet, electron beam, microwave, visible, infrared, or gamma radiation; or curing by evaporation of a solvent. Identity and amounts of curing agents, along with times and temperatures of curing may vary depending on the particular composition as is well known in the art.

Any of various conventional additives can be used in conjunction with plastic and micronized silver compositions of the present invention including, but not limited to, an accelerator, a crosslinker, a UV absorbing agent, a coloring agent, an opacifier, a plasticizer, a wetting agent, a preservative, a surfactant, a lubricant, a filler. One or more additives can be used in conventional amounts in plastic and micronized silver compositions of the present invention. Such additives and their use are known in the art as exemplified in Zweifel et al., Plastics Additives Handbook, Hanser Gardner Publications, 5th Ed., 2001.

In certain embodiments, plastic made to form water bottles, such as polycarbonate, is molded to include a colloidal ionic silver that will bind up hazardous leaching chemicals found in polycarbonates, such as bisphenol-A, and keep them out of the drinking water found therein. Besides absorbing the hazardous leaching elements from the polycarbonate the well-known anti-microbial properties of ionic colloidal silver will be present in the water contained in the bottle. Additionally, the anti-microbial properties and immune-boosting activity of the colloidal ionic silver will be transferred through dermal exposure to the person holding a water bottle, since the bottle is made of plastic molded with colloidal ionic silver.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

Any patents or publications mentioned in this specification are incorporated herein by reference to the same extent as if each individual publication is specifically and individually indicated to be incorporated by reference.

1. An article of manufacture for containing a substance, comprising:
a wall defining an internal space, the wall having an exterior surface, an opposing interior surface adjacent the internal space and a wall thickness extending between the exterior surface and interior surface, the wall comprising plastic and micronized silver, wherein the plastic and micronized silver are present in the container wall thickness extending between the exterior surface and interior surface.

2. The article of manufacture of claim 1, wherein the plastic comprises a bisphenol A polycarbonate.

3. The article of manufacture of claim 1, wherein the plastic comprises a bisphenol A epoxy resin.

4. The article of manufacture of claim 1 configured as a container.

5. The article of manufacture of claim 1 configured as a container liner.
